(19) United States
(12) Patent Application Publication
(10) Pub. No.: US 2024/0233619 A9
(43) Pub. Date: Jul. 11, 2024

(54) DISPLAY DEVICE AND METHOD OF OPERATING A DISPLAY DEVICE

(71) Applicant: ams-OSRAM International GmbH, Regensburg (DE)

(72) Inventors: Igor STANKE, Regensburg (DE); Julia STOLZ, Dresden (DE); Marc PHILIPPENS, Regensburg (DE)

(21) Appl. No.: 18/278,248

(22) PCT Filed: Feb. 22, 2022
(86) PCT No.: PCT/EP2022/054358

§ 371 Date: Aug. 22, 2023

(30) Foreign Application Priority Data
Feb. 23, 2021 (DE) 10 2021 104 246.1

(51) Int. Cl. G09G 3/32

(52) U.S. Cl. CPC G09G 3/32; G09G 2300/0852; G09G 2310/0275

(57) ABSTRACT

A display device includes a first pixel with a first sub-pixel. The display device also includes a second pixel with a second sub-pixel. The first sub-pixel includes a first light-emitting device, a first transistor, and a first driver circuit. The first driver circuit is coupled on its output side to a control terminal of the first transistor. The first transistor is coupled to the first light-emitting device. The second sub-pixel includes a second transistor and a second driver circuit. The second driver circuit is coupled on its output side to a control terminal of the second transistor. The second transistor is coupled to the first light-emitting device.

A display device and a method of operating a display device are disclosed.

A display device comprises an array of pixels. Typically, the pixels comprise light-emitting devices such as light-emitting diodes, abbreviated LED. Frequently, display devices are implemented as RGB display devices. Thus, a pixel, also called a pixel, of a display device comprises three sub-pixels, also called sub-pixels. Typically, the sub-pixels each comprise a light-emitting device that emits electromagnetic radiation in the corresponding wavelength range. If a light-emitting device is defective, this will affect the quality of the display device. Therefore, redundant light-emitting devices may be present, for example.

One object is to specify a display device and a method for operating a display device in which the number of light-emitting devices is kept low.

These objects are solved by a display device and a method for operating a display device according to the independent claims. Further embodiments of the display device and the method for operating a display device are the subject of the dependent claims.

In at least one embodiment, a display device comprises a first pixel having a first sub-pixel and a second pixel having a second sub-pixel. The first sub-pixel comprises a first light-emitting device, a first transistor, and a first driver circuit. The first driver circuit is output coupled to a control terminal of the first transistor. The first transistor is coupled to the first light-emitting device. The second sub-pixel comprises a second transistor and a second driver circuit. The second driver circuit is output coupled to a control terminal of the second transistor. The second transistor is coupled to the first light-emitting device.

Advantageously, the first light-emitting device is driven by the first and second driver circuits. The current flow through the first light-emitting device, and thus a value of the radiation emitted by the first light-emitting device, thus depends on the output signals of the first and/or the second driver circuit. By radiation is meant electromagnetic radiation.

According to at least one embodiment, the display device comprises a plurality of pixels. The plurality of pixels comprises the first pixel and the second pixel.

According to at least one embodiment, the display device comprises a first supply terminal and a second supply terminal. A parallel circuit of the first and second transistors couples the first supply terminal to a summation node. The first light-emitting device couples the summation node to the second supply terminal.

According to at least one embodiment of the display device, the first sub-pixel comprises a first capacitor coupling the control terminal of the first transistor to the first supply terminal. The second sub-pixel comprises a second capacitor coupling the control terminal of the second transistor to the first supply terminal.

According to at least one embodiment of the display device, the first driver circuit is configured to control the first transistor in response to a first data signal supplied to the first driver circuit. The second driver circuit is configured to control the second transistor in response to a second data signal supplied to the second driver circuit.

According to at least one embodiment of the display device, the first sub-pixel comprises a second light-emitting device and a third transistor. The first driver circuit is coupled on its output side to a control terminal of the third transistor. The third transistor coupled to the second light-emitting device. The second sub-pixel comprises a third light-emitting device and a fourth transistor. The second driver circuit is output coupled to a control terminal of the fourth transistor. The fourth transistor is coupled to the second light-emitting device.

According to at least one embodiment of the display device, the first, the second, and the third light-emitting devices are arranged adjacent to each other. For example, the first light-emitting device is disposed between the second and third light-emitting devices. The first, second, and third light-emitting devices are configured to emit radiation in the same wavelength range. The first, the second and the third light-emitting device thus have the same color location or the same emission color or reproduce the same color impression.

According to at least one embodiment of the display device, the first driver circuit is configured to control the first transistor and the second transistor such that, in a first mode of operation, the second light-emitting device emits radiation and, in a second mode of operation, the first light-emitting device emits radiation. An operating mode may also be referred to as an operating mode, an operating phase, or an operating state. In one example, in the first mode of operation, the first light-emitting device and the second light-emitting device are functional; further, in the second mode of operation, the second light-emitting device is non-functional and the first light-emitting device is functional. During an initial start-up and/or a calibration and/or a measurement, it is determined which transistors and/or which light-emitting devices can be used. An automatic detection of defective pixels is optionally also possible. A light-emitting device is not functional if the light-emitting device, such as a μLED, is defective or outside the specified parameters. This information is stored e.g. in a control circuit, which is realized e.g. as an integrated circuit.

According to at least one embodiment of the display device, the second driver circuit is configured to control the second and fourth transistors such that, in the first mode of operation, the first light-emitting device emits radiation and, in a third mode of operation, the third light-emitting device emits radiation. In the third mode of operation, the first light-emitting device is inoperative and the third light-emitting device is operative; further, in the third mode of operation, the first driver circuit is configured to control the first and second transistors such that the second light-emitting device emits radiation.

According to at least one alternative embodiment of the display device, the first and second driver circuits are configured to control the first, second, third, and fourth transistors such that, in a first mode of operation, the second and third light-emitting devices emit radiation and, in a second mode of operation, the first and second light-emitting devices or the first and third light-emitting devices or only the first light-emitting device emit radiation. The first and second light-emitting devices emit radiation if the third light-emitting device is inoperative. The first and third light-emitting devices emit radiation if the second light-emitting device is inoperative.

According to at least one embodiment of the display device, the first, second and third light-emitting devices are free of coupling to further pixels or sub-pixels of the display device. The first, second and third light-emitting devices are driven exclusively by the first and second driver circuits.

According to at least one embodiment, the display device comprises a third pixel comprising a third sub-pixel. The third sub-pixel comprises a fourth light-emitting device, a fifth transistor and an additional transistor, and a third driver circuit. The third driver circuit is output-coupled to a control terminal of the fifth transistor and a control terminal of the additional transistor. The fifth transistor is coupled to the first light-emitting device. The additional transistor is coupled to the fourth light-emitting device. The third driver circuit is configured to control the fifth transistor and the additional transistor such that, in the first mode of operation, the fourth light-emitting device emits radiation and, in a fourth mode of operation, the first light-emitting device emits radiation.

According to at least one embodiment, the display device comprises a fourth pixel comprising a fourth sub-pixel. The fourth sub-pixel comprises a fifth light-emitting device, a sixth transistor and another transistor, and a fourth driver circuit. The fourth driver circuit is output-coupled to a control terminal of the sixth transistor and a control terminal of the other transistor. The sixth transistor is coupled to the fifth light-emitting device. The other transistor is coupled to the first light-emitting device. Thus, advantageously, the first light-emitting device can emit radiation upon failure of the second, third, fourth, and/or fifth light-emitting devices.

According to at least one embodiment, the display device comprises a first pixel comprising a first sub-pixel. The first sub-pixel comprises a first and a second light-emitting device, a first and a further transistor and a first driver circuit. The first driver circuit is output coupled to a control terminal of the first transistor and a control terminal of the further transistor. The first transistor is coupled to the first light-emitting device. The further transistor is coupled to the second light-emitting device.

According to at least one embodiment of the display device, the first driver circuit is configured to control the first transistor and the further transistor such that in a first mode of operation the second light-emitting device emits radiation and in a second mode of operation the first light-emitting device emits radiation. The second operating mode is set, for example, in the event that the second light-emitting device is inoperative.

In at least one embodiment, a method of operating a display device comprising first and second pixels is disclosed. A first sub-pixel of the first pixel comprises a first light-emitting device, a first transistor, and a first drive circuit. A second sub-pixel of the second pixel comprises a second transistor and a second driver circuit. In this regard, the method comprises:
Outputting a first control voltage to the first transistor through the first driver circuit,
setting a first current flowing through the first transistor as a function of the first control voltage,
outputting a second control voltage to the second transistor through the second driver circuit,
setting a second current flowing through the second transistor as a function of the second control voltage; and
emitting electromagnetic radiation through the first light-emitting device as a function of the sum of the first and second currents.

The method described herein is particularly suitable for the operation of the display device described herein. The features described in connection with the display device can therefore also be used for the method and vice versa.

According to at least one embodiment, the display device relates to a pixel scheme for micro-LED displays with a smaller number of LEDs. The display device is designed as a μLED based display. The display device can be used for display or video wall applications. The cost of manufacturing a μLED display depends to a large extent on the number of LEDs used. Costs can be reduced by reducing the number of μLEDs in redundancy pixels, which can also be called secondary pixels, and/or primary pixels.

According to at least one embodiment, the display device comprises pixels realized as red-green-blue pixels, abbreviated RGB pixels. A pixel may also be called a pixel. A pixel comprises at least one sub-pixel, for example a red sub-pixel, a green sub-pixel and/or a blue sub-pixel. Typically, each sub-pixel comprises a light-emitting device, such as a light-emitting diode, abbreviated as LED, or a micro light-emitting diode, abbreviated as μLED. The display device may also be called a display. Embodiments of μLED display are based on RGB pixels, with one micro LED per color in a primary pixel. In some cases, additional redundant LEDs are installed in a secondary pixel to improve the yield, but these are only put into operation if the first LED fails.

According to at least one embodiment of the display device, a light-emitting device such as an LED can advantageously be driven by two or more transistors simultaneously, so that IL=IT1+IT2+ . . . ITn.

For example, primary pixels are each equipped with dedicated RGB LEDs. Two (or more) adjacent redundant secondary pixels share RGB LEDs. If one LED in the primary pixel is defective, the system switches to the secondary pixel. If both (more) primary pixels have defects, the secondary pixel can be shared by both (more) primary pixels. Transistors can be manufactured as thin-film transistors, abbreviated TFTs.

In an alternative embodiment, no dedicated secondary LEDs are used. If an LED in the primary pixel is faulty, the primary LED of the neighboring pixel can be shared so that the current through the LED is the sum of the currents of the two TFTs.

Alternatively, one LED (red and/or blue) is driven by two TFTs of the adjacent primary subpixels. The visible resolution is mainly dominated by the number of green LEDs, thus the number of red and blue LEDs can be reduced.

According to at least one embodiment, the display device is designed to achieve brightness control via current control, via pulse width modulation or a combination of both methods. Thus, this circuit can be used with both TFT and μIC based displays. Circuits can be designed with both p-channel metal-oxide-semiconductor field-effect transistors, abbreviated PMOSFET, (e.g. using low-temperature polysilicon, abbreviated LTPS or Si as substrate) and n-channel metal-oxide-semiconductor field-effect transistors, abbreviated NMOSFET (e.g. using indium gallium zinc oxide, abbreviated IGZO, amorphous silicon, abbreviated aSi, or Si as substrate).

The display device may comprise a matrix or array of pixels, also called pixels or pixel cells, each having at least one sub-pixel.

According to at least one embodiment, the display device is implemented as a single-color display device (such as a black-and-white display device). Then, a pixel comprises exactly one sub-pixel.

According to at least one alternative embodiment, the display device is implemented as a colored display device, such as an RGB display device. Then, a pixel may comprise three sub-pixels, such as a “red”, a “green” and a “blue” sub-pixel.

According to at least one embodiment of the display device, the first, second, third, fourth, fifth and the further light-emitting semiconductor devices are realized as light-emitting diodes, abbreviated as LEDs, or micro light-emitting diodes, abbreviated as μLEDs. These can be formed from a III/V compound semiconductor material or from a II/VI compound semiconductor material. For example, a μLED may be made of indium gallium nitride InGaN. Alternatively, an LED can be realized as an organic light-emitting diode, abbreviated OLED.

According to at least one alternative embodiment of the display device, the light-emitting device is realized as a laser diode, for example as a vertical-cavity surface-emitting laser, abbreviated VCSEL.

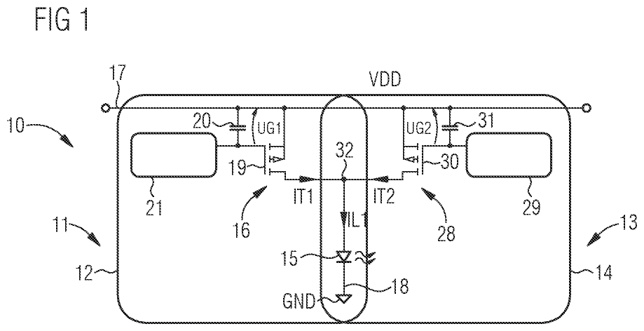

Further embodiments and further embodiments of the display device or of the method for operating a display device result from the embodiment examples explained below in connection with FIGS. 1 to 7B. Identical, similar or identically acting circuit parts and components are provided with the same reference signs in the figures. They show:

FIGS. 1, 2, 3A to 3C, 4 and 5 show an exemplary embodiment of a display device;

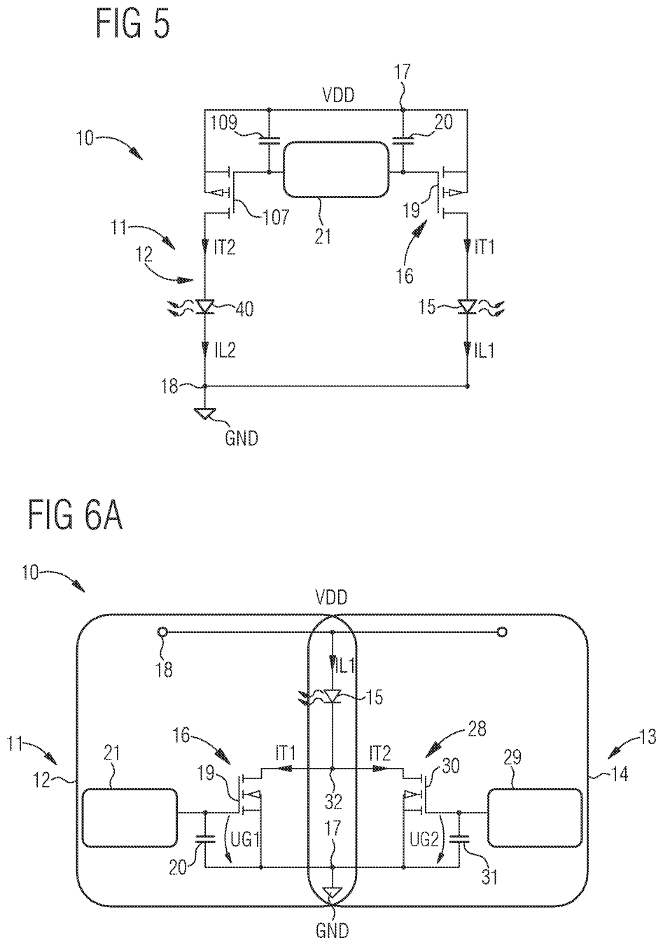

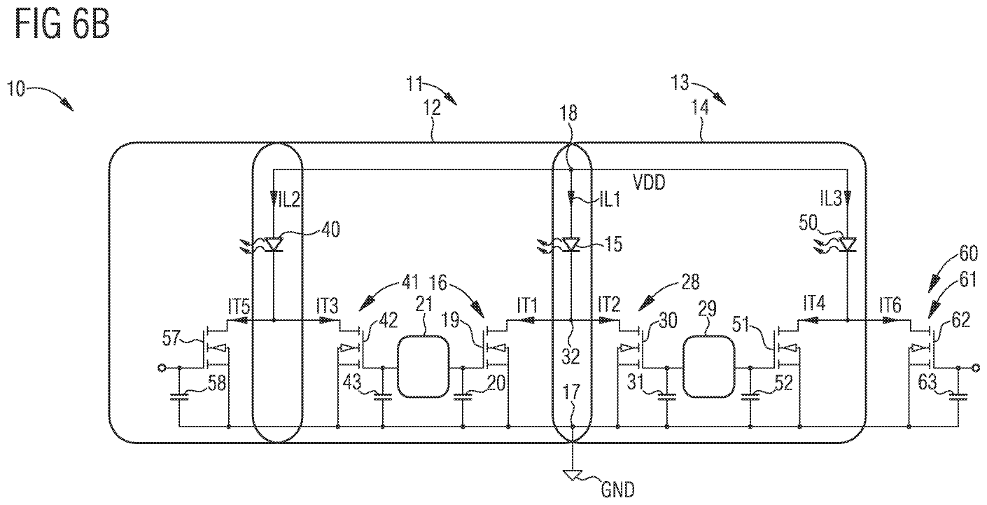

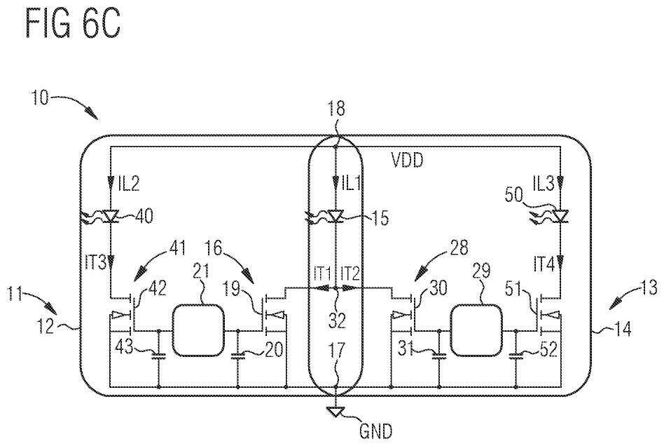

FIGS. 6A to 6C show further exemplary embodiments of a display device; and

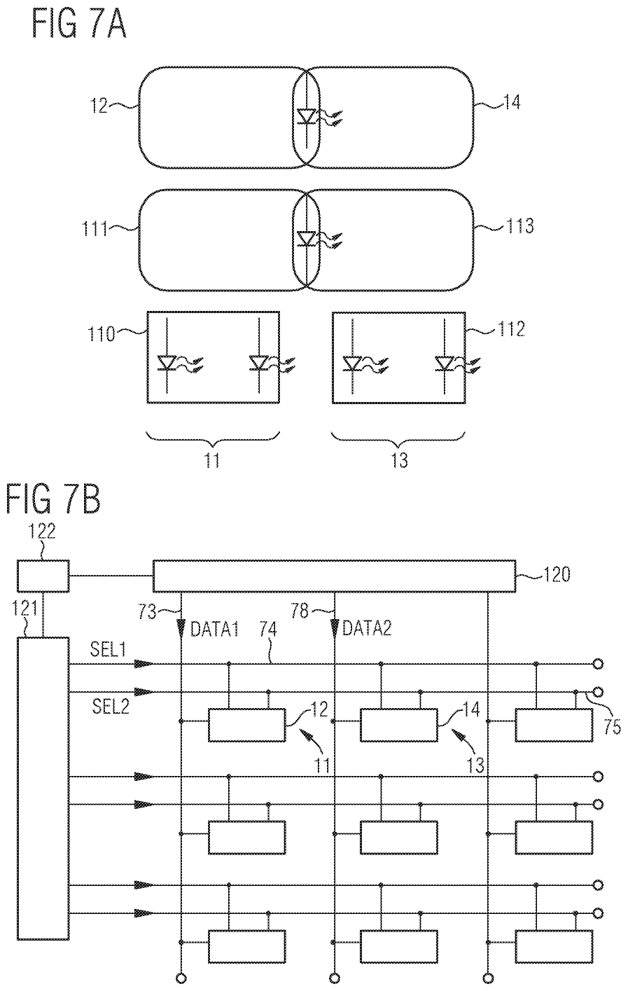

FIGS. 7A and 7B show exemplary embodiments of a display device.

FIG. 1 shows an exemplary embodiment of a display device 10. The display device 10 comprises a first pixel 11, which comprises a first sub-pixel 12. Further, the display device comprises a second pixel 13 comprising a second sub-pixel 14. The first sub-pixel 12 comprises a first light-emitting device 15. The first light-emitting device 15 is implemented as a semiconductor light-emitting device. The first light-emitting device 15 is implemented as a light-emitting diode, abbreviated as LED.

Further, the first sub-pixel 12 comprises a first transistor 16 coupled to the first light-emitting device 15. By coupled, it is meant that a terminal of a controlled path of the first transistor 16 is coupled to a terminal of the first light-emitting device 15 or is connected to a terminal of the first light-emitting device 15. The pixel 11 comprises first and second supply terminals 17, 18. The second supply terminal 18 may be implemented, for example, as a reference potential terminal. A series circuit of the first transistor 16 and the first light-emitting device 15 is arranged between the first supply terminal 17 and the second supply terminal 18. For example, the first light-emitting device 15 is connected to the second supply terminal 18. The first transistor 16 couples the first supply terminal 17 to a summation node 32. The first light-emitting device 15 couples the summation node 32 to the second supply terminal 18. A cathode of the first light-emitting device 15 is connected to the second supply terminal 18. An anode of the first light-emitting device 15 is connected to the summation node 32. A control terminal 19 of the first transistor 16 is coupled to the first supply terminal 17 via a first capacitor 20 of the first sub-pixel 12. The first capacitor 20 functions as a storage capacitor.

The first sub-pixel 12 comprises a first driver circuit 21. An output of the first driver circuit 21 is connected to the control terminal 19 of the first transistor 16. The first transistor 16 may be fabricated as a thin-film transistor, abbreviated as TFT. The first driver circuit 21 comprises thin-film transistors for driving the sub-pixel 12. The display device 10 is formed as a μLED based display.

The second sub-pixel 14 comprises a second transistor 28 and a second drive circuit 29, an output of the second drive circuit 29 being connected to a control terminal 30 of the second transistor 28. A second capacitor 31 of the second sub-pixel 14 couples the control terminal 30 of the second transistor 28 to the first supply terminal 17. The second transistor 28 is coupled to the first light-emitting device 15. Thus, a terminal of a controlled path of the second transistor 28 is coupled to a terminal of the first light-emitting device 15 or connected to a terminal of the first light-emitting device 15. Thus, the second transistor 28 couples the first supply terminal 17 to the summation node 32 and thus to the first light-emitting device 15, more specifically to the anode of the first light-emitting device 15.

The first and the second transistor 16, 28 are implemented as field effect transistors, in particular as p-channel transistors. The first and the second transistor 16, 28 are implemented as metal oxide semiconductor field effect transistors, abbreviated MOSFET, e.g. as p-channel MOSFET.

A supply voltage VDD is applied to the first supply connection 17. A reference potential GND is applied to the second supply terminal 18. The first transistor 16 is controlled by a first control voltage UG1, which is output by the first driver circuit 21. Accordingly, the second transistor 28 is controlled by a second control voltage UG2 output from the second driver circuit 29. The first control voltage UG1 is applied, for example, between the control terminal 19 of the first transistor 16 and the first supply terminal 17. The second control voltage UG2 is applied, for example, between the control terminal 30 of the second transistor 28 and the first supply terminal 17. As a function of the first control voltage UG1, a first current IT1 flows through the first transistor 16. Accordingly, as a function of the second control voltage UG2, a second current IT2 flows through the second transistor 28. A first operating current IL1 flows through the first light-emitting device 15. The first operating current IL1 is the sum of the first current IT1 and the second current IT2. The first light-emitting device 15 emits electromagnetic radiation as a function of the first operating current IL1, and thus as a function of the sum of the first current IT1 and the second current IT2. Advantageously, one light-emitting device, namely the first light-emitting device 15, can be driven simultaneously by two transistors, for example by two TFTs, so that:

IL1=IT1+IT2

In the example display device 10 shown in FIG. 1, the first sub-pixel 12 is free of another light-emitting device. The second sub-pixel 14 is free of a light-emitting device. Thus, the number of light-emitting devices of the first sub-pixel 12 and the second sub-pixel 14 together is exactly 1. The first and second sub-pixels 12, 14 use the first light-emitting device 15 to emit electromagnetic radiation. The first light-emitting device 15 is thus the common light-emitting device of the first and second sub-pixels 12, 14. The first and second sub-pixels 12, 14 are designed to emit electromagnetic radiation in the same wavelength range. For example, the first and second sub-pixels 12, 14 are both designed to be red pixels or both designed to be blue pixels.

An LED (red and/or blue) implementing the first light-emitting device 15 is driven by two TFTs 16, 28 of the adjacent primary subpixels 12, 14. The visible resolution is mainly dominated by the number of green LEDs, thus the number of red and blue LEDs can be reduced.

In FIG. 1 the structure of a display device 10, also called display, is illustrated: The first transistor 16 as well as the first light-emitting device 15, realized as μLED, is in the first pixel 11 or first sub-pixel 12. The second transistor 28 is in the second pixel 13 or second sub-pixel 14, which also uses the first light-emitting device 15. The first operating current IL1 through the first light-emitting device 15 is the sum of the currents through the first and second transistors 16, 28. The circuitry is implemented in the same manner for one or more LEDs in the first pixel 11. The sub-pixels 12, 14 shown in FIG. 1 are particularly suitable for red and blue sub-pixels.

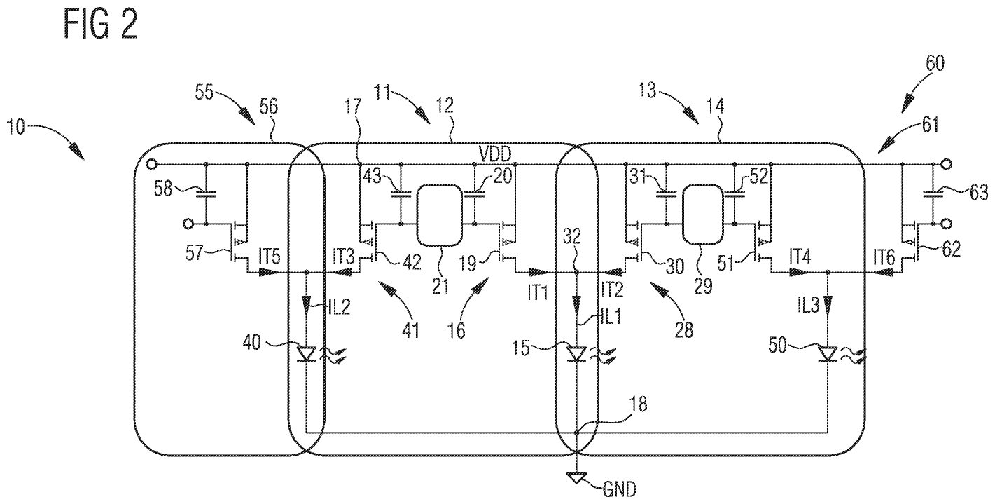

FIG. 2 shows an alternative embodiment of a display device 10, which is a further development of the embodiment shown in FIG. 1. The first sub-pixel 12 comprises a second light-emitting device 40, the second light-emitting device 40 being implemented in the same manner as the first light-emitting device 15. In addition, the first sub-pixel 12 comprises a third transistor 41 having a control terminal 42 connected to another output of the first driving circuit 21. A third capacitor 43 couples the control terminal 42 of the third transistor 41 to the first supply terminal 17. The third transistor 41 couples the third light-emitting device 40 to the first supply terminal 17. The second light-emitting device 40 is connected to the second supply terminal 18.

The second sub-pixel 14 comprises a third light-emitting device 50. Further, the second sub-pixel 14 comprises a fourth transistor 51. The fourth transistor 51 couples the third light-emitting device 50 to the first supply terminal 17. Another output of the second driver circuit 29 is connected to a control terminal of the fourth transistor 51. A fourth capacitor 52 of the second sub-pixel 14 couples the control terminal of the fourth transistor 51 to the first supply terminal 17.

As shown in FIG. 2, the display device 10 may comprise a third pixel 55 having a third sub-pixel 56. The third sub-pixel 56 comprises a fifth transistor 57 coupled to the second light-emitting device 40. Similarly, the display device 10 may comprise a fourth pixel 60 comprising a fourth sub-pixel 61. The fourth sub-pixel 61 comprises a sixth transistor 62 that couples the third light-emitting device 50 to the supply terminal 17. The third and fourth pixels 55, 60 are only indicated. The third and fourth pixels 55, 60 may be implemented in the same manner as the first pixel 11. The third and fourth pixels 55, 60 comprise a fifth capacitor 58 and a sixth capacitor 63.

The first driver circuit 21 outputs a third control voltage UG3 to the control terminal 42 of the third transistor 41. The first driving circuit 21 sets the third transistor 41 such that a third current IT3 flows through the third transistor 41. Thus, an operating current IB2 flowing through the second light-emitting device 40 has at least the value of the third current IT3.

The display device 10 may be in a first mode of operation or a second mode of operation. An operating mode may also be called an operating phase or an operating mode. In the first mode of operation, the first driver circuit 21 drives the third transistor 41 such that the second light-emitting device 40 emits electromagnetic radiation. On the other hand, the first driving circuit 21 drives the first transistor 16 such that the value of the first current IT1 is 0, i.e. the first transistor 16 does not emit any current to the first light-emitting device 15. In the first operating mode, the second driving circuit 29 drives the second transistor 28 such that it outputs a second current IT2 (which is not 0) to the first light-emitting device 15 and the first light-emitting device 15 emits electromagnetic radiation. Further, the second driving circuit 29 drives the fourth transistor 51 such that the value of a fourth current IT4 is 0, that is, the fourth transistor 51 does not output a current to the third light-emitting device 50.

The display device 10 is set in the first mode of operation if the second light-emitting device 40 is functional.

If the second light-emitting device 40 is inoperative, the display device 10 is set to the second operating mode. In this case, the first drive circuit 21 outputs the first control voltage UG1 such that a first current IT1 (which is not 0) flows through the first transistor 16. The first operating current IL1 thus has at least the value of the first current IT1. Optionally, the first driver circuit 21 can output the third control voltage UG3 such that the third transistor 41 is switched to a non-conducting state.

In the second operating mode, the second drive circuit 29 further outputs the second control voltage UG2 such that the second current IT2 (which is not equal to 0) flows through the second transistor 28 and thus also through the first light-emitting device 15. The first operating current IL1, which flows through the first light-emitting device 15, is thus the sum of the first and the second current IT1, IT2 (IL1=IT1+IT2). Advantageously, the first light-emitting device 15 thus assumes the function of a light-emitting device for both the first sub-pixel 12 and the second sub-pixel 14 in the event that the second light-emitting device 40 is inoperative.

Thus, in the first mode of operation, the various light-emitting devices are predetermined to emit electromagnetic radiation of a single sub-pixel, respectively. In the second mode of operation, the sub-pixels with a non-functional light-emitting device use an adjacent light-emitting device instead of the non-functional light-emitting device to emit electromagnetic radiation.

In this example, no dedicated secondary LEDs are used. If an LED in the first pixel 11 (also called primary pixel) is faulty, the light-emitting device of the neighboring pixel, such as the second pixel 13, can be shared so that the current through the LED is the sum of the currents of the two TFTs. In one option, the use of the dedicated LEDs in the secondary pixel is completely omitted. With advantage a high saving potential is achieved. If a primary pixel is defective, an adjacent pixel is shared. If two neighboring pixels are defective, compensation is no longer possible.

In FIG. 2, the structure of a display is shown: the first light-emitting device 15 can be used as a primary LED by the second sub-pixel 14 and as a secondary LED by the first sub-pixel 12. The second light-emitting device 40 may be used as a primary LED by the first sub-pixel 12 and as a secondary LED by the third sub-pixel 56. The third light-emitting device 50 may be used as a primary LED by the fourth sub-pixel 61 and as a secondary LED by the second sub-pixel 14. The circuitry is implemented in the same way for all three light-emitting devices 15, 40, 50.

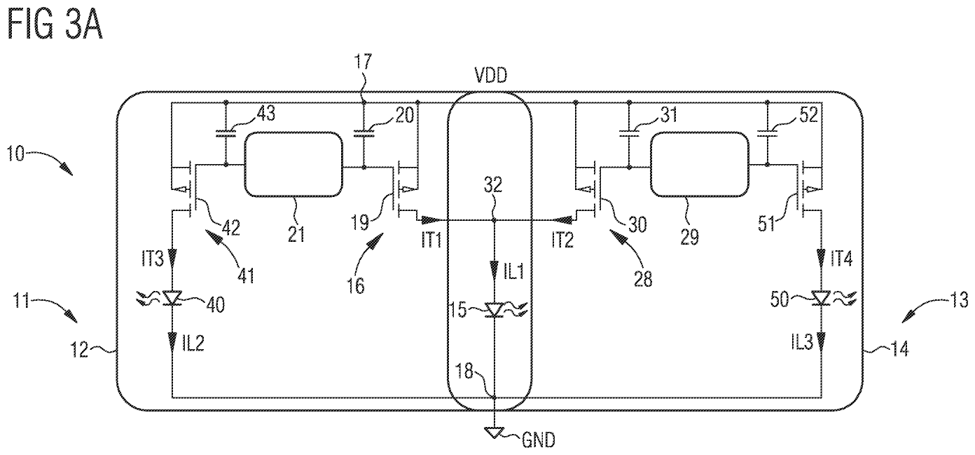

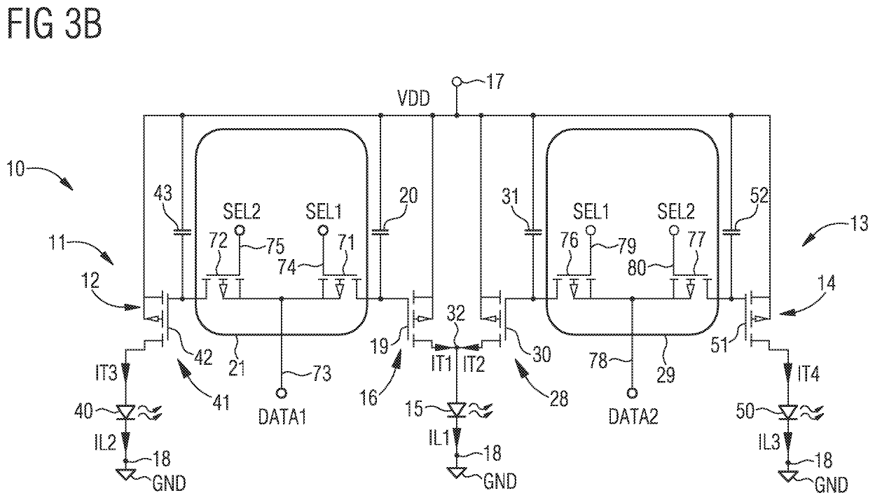

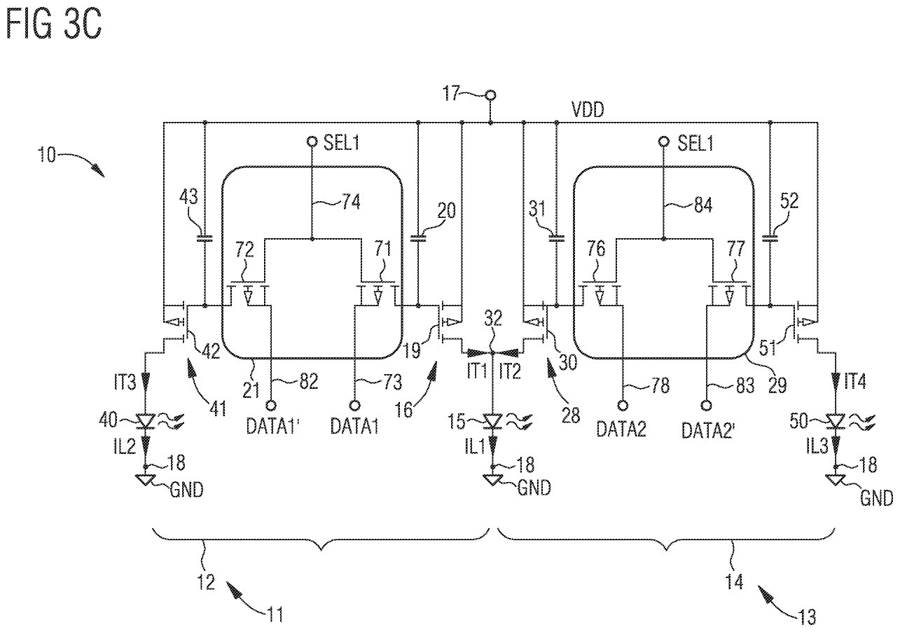

FIG. 3A shows another exemplary embodiment of a display device 10, which is a further development of the embodiments shown in FIGS. 1 and 2. The first sub-pixel 13 comprises the first and second light-emitting devices 15, 40, the first driver circuit 21, the first and third transistors 16, 41, and the first and third capacitors 20, 43. The second sub-pixel 14 comprises the third light-emitting device 50, the second and fourth transistors 28, 51, the second and fourth capacitors 31, 52, and the second driver circuit 29.

In a first mode of operation of the first sub-pixel 12, the second light-emitting device 40 is operative. Thus, the first driver circuit 21 drives the third transistor 41 such that the second light-emitting device 40 emits electromagnetic radiation. In this case, the first transistor 16 is non-conductively connected by the first driver circuit 21. In a first mode of operation of the second sub-pixel 14, the second driver circuit 29 drives the fourth transistor 51 such that the third light-emitting device 50 emits electromagnetic radiation. Further, the second driver circuit 29 turns the second transistor 28 non-conductive.

However, if the second light-emitting device 40 is not functional, the first driver circuit 21 sets the first transistor 16 such that the first light-emitting device 15 emits electromagnetic radiation. The first driver circuit 21 outputs the first control voltage UG1 to the first transistor 16 such that the first current IT1 (other than 0) flows through the first transistor 16 and thus also through the first light-emitting device 15. The first sub-pixel 12 is thus in a second operating mode.

However, if the third light-emitting device 50 is inoperative, the second driver circuit 29 sets the second transistor 28 such that the first light-emitting device 15 emits electromagnetic radiation. The second driving circuit 29 outputs the second control voltage UG2 to the second transistor 28 such that the second current IT2 (which is not 0) flows through the second transistor 28 and thus also through the first light-emitting device 15. The second sub-pixel 14 is thus in a second operating mode.

If the second and/or the third light-emitting device 40, 50 are not functional, an operating current IL1 flows through the first light-emitting device 15, which is the sum of the first current IT1 and the second current IT2. Here, the first current IT1 and the second current IT2 have a non-zero value. The following applies: IL1=IT1+IT2

Advantageously, one light-emitting device, namely the first light-emitting device 15, can be used as a spare device in case of failure of one of the other light-emitting devices 40, 50. Thus, it is not necessary to provide a separate substitute device for each sub-pixel 12, 14. Advantageously, the first light-emitting device 15 can be driven by two or more transistors simultaneously. Primary pixels are each equipped with a dedicated RGB LED. Two (or more) adjacent redundant secondary pixels each share RGB LEDs. If one LED in the primary pixel is defective, the system switches to the secondary pixel. If both (several) primary pixels have defects, one secondary pixel can be shared by both (several).

In FIG. 3A the structure of a display is illustrated: The first transistor 16 as well as the first light-emitting device 15 form the control of the LEDs in the primary pixel. The third transistor 41 and the second light-emitting device 40 control the LEDs in the primary pixel. The first and second transistors 16, 28 and the first light-emitting device 15 form the driving of the LED in the common secondary pixel. The circuitry is implemented in the same manner for all three LEDs in the pixel. The number of LEDs in the secondary pixel is reduced by 50% or more. Due to the high expected transfer rate, only a few secondary pixels are put into operation. If a primary pixel is defective, it will be replaced by secondary pixels as in the standard circuit. If both (several) pixels have a defect, the sum of the currents needed to drive the individual pixels flows through the LED (IL=IT1+IT2+ . . . ITn). A visual impression in high resolution displays is not disturbed much by a lower number of secondary pixels. This case is unlikely due to the expected high transfer rate.

FIG. 3B shows an exemplary embodiment of a display device 10 that is a further development of the embodiments shown in FIGS. 1, 2 and 3A. FIG. 3B shows details of first and second driver circuits 21, 29. The first driver circuit 12 comprises first and second select transistors 71, 72, English select transistor. A first data line 73 of the display device 10 is coupled to the control terminal 19 of the first transistor 16 via the first select transistor 71. Further, the first data line 73 is coupled to the control terminal of the third transistor 41 via the second select transistor 72.

A first selection line 74 is coupled to a control terminal of the first selection transistor 71. Further, a second selection line 75 of the display device 10 is connected to a control terminal of the second selection transistor 72. The first data line 73 may be designated as a column line. The first and second selection lines 74, 75 may be designated as row lines. The first and second selection transistors 71, 72 are implemented as field effect transistors of the same channel type; for example, of the same channel type as the first, second, third and fourth transistors 16, 28, 41, 51. Thus, the first and second selection transistors 71, 72 are either both n-channel MOSFETs or both p-channel MOSFETs.

The display device 10 is designed to detect which light-emitting devices are non-functional. Functional and non-functional light-emitting devices are determined by a first measurement and/or by a calibration. A functional light-emitting device may also be referred to as a functioning light-emitting device. Optionally, an automatic detection of defective pixels and/or light-emitting devices and/or transistors is performed by the display device 10. A first data signal DATA1 can be tapped at the first data line 73. If the display device 10 detects that, for example, the second light-emitting device 40 is functional, a first select signal SELL on the first select line 74 sets the first select transistor 71 to a non-conducting state and a second select signal SEL2 on the second select line 75 sets the second select transistor 72 to a conducting state, so that the first data signal DATA1 is stored in the third capacitor 43 and sets the third transistor 41. The value of the third current IT3 is thus set by the value of the first data signal DATA1.

Before or after this, the second selection signal SEL2 on the second selection line 75 switches the second selection transistor 72 to non-conducting and the first selection signal SELL on the first selection line 74 switches the first selection transistor 71 to conducting, so that the first data signal DATA1 is fed to the first capacitor 20 and the first transistor 16 via the first selection transistor 71. In the first operating mode, for example, the data signal DATA1 has the value of the supply voltage VDD, so that the first transistor 16 is switched to non-conducting.

Accordingly, the second driver circuit 29 comprises third and fourth select transistors 76, 77. A second data line 78 of the display device 10 is coupled to the control terminal 30 of the second transistor 28 via the third select transistor 76. Further, the second data line 78 is coupled to the control terminal of the fourth transistor 51 via the fourth selection transistor 77. A third selection line 79 is coupled to a control terminal of the third selection transistor 76. Further, a fourth selection line 80 of the display device 10 is connected to a control terminal of the fourth selection transistor 77. The operation of the second driver circuit 29 is the same as the operation of the first driver circuit 21, and the third selection line 79 may be conductively connected to or identical to the first selection line 74. The fourth selection line 80 may be conductively connected to the second selection line 75 or may be identical.

The display device 10 thus comprises approximately twice the number of selection lines compared to a display device without the use of a secondary pixel, i.e. without the possibility of switching to an adjacent light-emitting device in the event of a fault. For example, a frame time is divided; in the first part, a first half of the selection lines is driven (such as for the second and third light-emitting devices 40, 50), and in the second part, a second half of the selection lines is driven (such as for the first light-emitting device 15).

FIG. 3C shows an exemplary embodiment of a display device that is a further development of the embodiments shown in the figures above. The first selection transistor 71 couples the first data line 73 to the first capacitor 19 and the first transistor 16. Further, the second selection transistor 72 couples another first data line 82 to the third capacitor 43 and the third transistor 42. The first selection line 74 is connected to the control terminal of the first selection transistor 71 and to the control terminal of the second selection transistor 72.

If the first and second selection transistors 71, 72 are switched to conductive with the aid of the first selection signal SELL, the first data signal DATA1, which is present on the first data line 73, is fed via the first selection transistor 71 to the first capacitor and the first transistor 16. Correspondingly, another data signal DATA1′, which is applied to the further first data line 82, is fed to the third transistor 41 and the third capacitor 43 via the second selection transistor 72. The first data signal DATA1 and the further first data signal DATA1′ remain stored in the respective capacitors 20, 43 until the selection signal SELL switches the two selection transistors 71, 72 to conductive again and changed data signals DATA1, DATA1′ are supplied to the first and third transistors 16, 41 via the conductive switched selection transistors 71, 72.

The second driver circuit 29 is implemented and functions like the first driver circuit 21. The third selection transistor 76 couples the second data line 78 to the second capacitor 31 and the second transistor 28. Further, the fourth selection transistor 77 couples another second data line 83 to the fourth capacitor 52 and the fourth transistor 51. A further selection line 84 is connected to the control terminal of the third selection transistor 76 and to the control terminal of the fourth selection transistor 77. The further selection line 84 may be conductively connected to the first selection line 74 or may be identical. The first selection signal SELL or a further selection signal may be present at the further selection line 84. The second data signal DATA2 is present at the second data line 78. A further second data signal DATA2′ is applied to the further second data line 83.

The driver circuits 21, 29 may also be implemented using alternative embodiments.

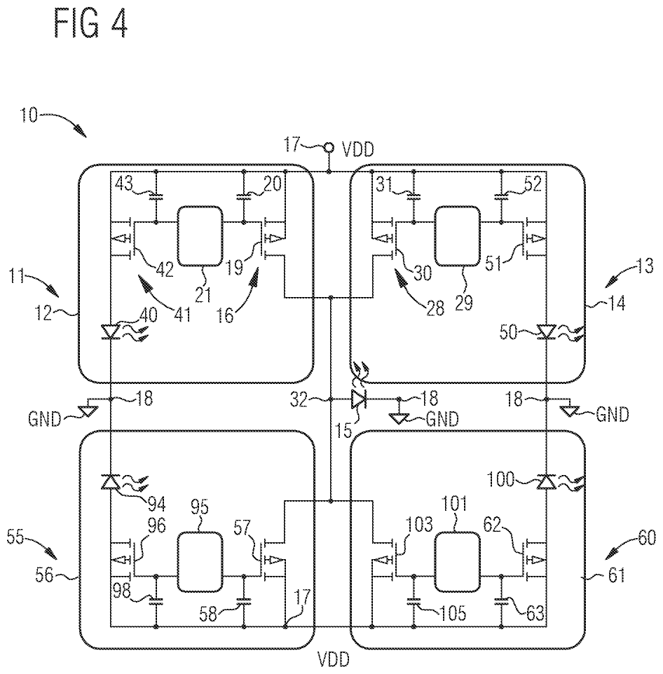

FIG. 4 shows another exemplary embodiment of a display device 10, which is a further development of the embodiments shown in the above figures. The display device 10 comprises the first and second pixels 11, 13 as also shown in FIGS. 3A to 3C. Additionally, the display device comprises the third pixel 55 having a third sub-pixel 56. Further, the display device 10 comprises the fourth pixel 60 having the fourth sub-pixel 61.

The third and fourth sub-pixels 56, 61 are implemented in the same manner as the first sub-pixel 12. Thus, the third sub-pixel 56 comprises a fourth light-emitting device 94, a third driver circuit 95, the fifth and an additional transistor 57, 96, and the fifth and an additional capacitor 58, 98. The third driver circuit 95 is coupled to the fourth light-emitting device 94 via the additional transistor 96. Further, the third driver circuit 95 is coupled to the first light-emitting device 15 via the fifth transistor 57.

The fourth sub-pixel 61 comprises a fifth light-emitting device 100, a fourth driver circuit 101, the sixth transistor 62, another transistor 103, the sixth capacitor 63, and another capacitor 105. The fourth driver circuit 101 is coupled to the fifth light-emitting device 100 via the sixth transistor 62. The fourth driver circuit 101 is coupled to the first light-emitting device 15 via the other transistor 103.

Thus, the first light-emitting device 15 is provided as a radiation emitting light-emitting device in the event that one of the light-emitting devices 40, 50, 94, 100 of the four sub-pixels 12, 14, 56, 61 is inoperative. Advantageously, the four pixels 11, 13, 55, 60 use a common light-emitting device, namely the first light-emitting device 15 as a backup device.

In one embodiment, the first light-emitting device 15 is arranged between the four light-emitting devices. The four pixels 11, 13, 55, 60 are arranged as an array, for example as a 2·2 array or matrix. The first light-emitting device is located, for example, in the center of the array.

In one embodiment, four primary pixels are provided per secondary pixel. FIG. 4 shows the structure of a display: The third transistor 41 as well as the second light-emitting device 40 form the control of the LED in the first sub-pixel 12 (first primary pixel). The fourth transistor 51 as well as the third light-emitting device 50 form the control of the LED in the second sub-pixel 14 (second primary pixel). The additional transistor 96 as well as the fourth light-emitting device 94 form the control of the LED in the third sub-pixel 56 (third primary pixel). The sixth transistor 62 and the fifth light-emitting device 100 form the drive of the LED in the fourth sub-pixel 61 (fourth primary pixel). The first, second, fifth and other transistors 16, 29, 57, 103 and the first light-emitting device 15 form the driving of the LED in the common secondary pixel. Wiring is performed in the same way for all LEDs in the sub-pixels.

Advantageously, four primary pixels use a common secondary pixel. Advantageously, a light-emitting device such as the first light-emitting device 15 can be driven by two or more transistors simultaneously, so that IL=IT1+IT2+ . . . ITn.

The primary pixels are each equipped with dedicated RGB LEDs. Two (or more) adjacent redundant secondary pixels share RGB LEDs. If one LED in the primary pixel is defective, the system switches to the secondary pixel. If both (several) primary pixels have defects, the secondary pixel can be used jointly by both (several).

FIG. 5 shows another exemplary embodiment of a display device 10, which is a further development of the embodiments shown above. The display device 10 comprises the first pixel 11 with the first sub-pixel 12. The sub-pixel 12 is realized as shown for example in FIG. 2. Thus, the first sub-pixel 12 comprises the first driver circuit 21, the first and second light-emitting devices 15, 40, the first transistor 16, a further transistor 107, the first capacitor 20, and a further capacitor 109. The first driver circuit 21 is coupled at a further output to a control terminal of the further transistor 107. The further transistor 107 is coupled to the second light-emitting device 40. The first driver circuit 21 may be implemented in the same manner as the first driver circuit 21 shown in FIGS. 3B and 3C. The first and second light-emitting devices 15, 40 are free from connection to transistors of other pixels or other sub-pixels.

In an example, if the second light-emitting device 40 is functional, the first driver circuit 21 sets the second current IT2 flowing through the second light-emitting device 40 to a value other than 0. Further, the first driver circuit 21 sets the first current IT1 to the value 0. Thus, the first operation mode is realized.

If the second light-emitting device 40 is inoperative, the first sub-pixel 12 is set to the second mode of operation in which the first driver circuit 21 sets the first current IT1 to a non-zero value. At the same time, the third current IT3 is set to zero. Advantageously, the first pixel 11 can be operated independently of other pixels. The first light-emitting device 15 may also be referred to as a secondary pixel and the second light-emitting device 40 may be referred to as a primary pixel. The transistors 16, 107 may be implemented as thin film transistors, abbreviated TFT.

The display device 10 is implemented as a μLED display and is based on RGB pixels, with one micro LED per color in the primary pixel. To improve the yield, one or more redundant LEDs are additionally installed in the secondary pixel, but they are only put into operation if the first LED fails. FIG. 5 shows the structure of an active-matrix display or active-matrix thin-film transistor display (abbreviated as AM TFT display). The further transistor 107 as well as the light-emitting device 40 realized as μLED form the control of the LEDs in the primary pixel. The first transistor 16 as well as the first light-emitting device 15 realized as μLED form the control of the LED in the secondary pixel. The circuitry is implemented in the same way for all three LEDs in the pixel. In case the LED of the primary pixel does not work, the primary pixel switches to the secondary pixel. Alternatively, a design without secondary pixel is also possible.

FIGS. 6A to 6C show alternative exemplary embodiments of a display device 10, which are further embodiments of the embodiments shown above. In FIGS. 6A to 6C, the first and second transistors 16, 28 are implemented as n-channel transistors. The first and second transistors 16, 28 are implemented as n-channel MOSFETs. Here, the first supply terminal 17 is implemented as a reference potential terminal. Thus, the reference potential GND is applied to the first supply terminal 17. The second supply terminal 18 is connected to a voltage source that is not shown. The supply voltage VDD is applied to the second supply connection 18. The circuit in FIG. 6A corresponds to the circuit in FIG. 1. The circuit in FIG. 6B corresponds to the circuit in FIG. 2. On the other hand, the circuit in FIG. 6C corresponds to the circuit in FIG. 3A. In FIGS. 6A to 6C, the first light-emitting device 15 is connected to the second supply terminal 18. In contrast, the cathode of the first light-emitting device 15 is coupled to the first supply terminal 17 via the summation node 32 and via the first transistor 16. The same applies to the cathodes and anodes of the other light-emitting devices.

The transistors of the display device 10 are designed as p-channel MOSFETs or/and n-channel MOSFETS (see FIGS. 6A to 6C for N-channel MOSFETs). The substrate used for fabricating the transistors may be, for example, silicon or indium-gallium-zinc oxide, abbreviated IGZO. The silicon can be a low temperature polysilicon, abbreviated LTPS, amorphous silicon, abbreviated aSi or monocrystalline silicon.

FIG. 7A shows an exemplary embodiment of a display device 10, which is a further development of the embodiments shown above. In FIGS. 7A and 7B, the display device 10 is shown only schematically. The first and second sub-pixels 12, 14 are implemented, for example, as shown in FIG. 1. The first pixel 11 comprises a first further sub-pixel 110 and a first additional sub-pixel 111. Similarly, the second pixel 13 comprises a second further sub-pixel 112 and a second additional sub-pixel 113. The first further sub-pixel 110, the first additional sub-pixel 111 and the first sub-pixel 12 may be implemented differently. For example, the first further sub-pixel 110 and the second further sub-pixel 112 are realized as shown in FIG. 5. The first sub-pixel 12, the second sub-pixel 14, the first additional sub-pixel 111, and the second additional sub-pixel 113 are implemented, for example, as the first and second sub-pixels 12, 14 shown in FIG. 1.

For example, the first and second sub-pixels 12, 14 are implemented to emit electromagnetic radiation in the red wavelength region. Further, the first additional and the second additional sub-pixels 112, 113 are implemented for emission of electromagnetic radiation in the blue wavelength region. The first additional sub-pixel 110 and the second additional sub-pixel 112 are implemented to emit electromagnetic radiation in the green wavelength region. Thus, an arrangement of the first and second pixels 11, 13 comprises exactly one light-emitting device for emission of electromagnetic radiation in the blue wavelength region, exactly one light-emitting device for emission of electromagnetic radiation in the red wavelength region, and at least two light-emitting devices (e.g. four light-emitting devices) for emission of electromagnetic radiation in the green wavelength region.

FIG. 7B shows an exemplary embodiment of a display device 10, which is a further development of the embodiments shown above. The display device comprises a column driver circuit 120 and a row driver circuit 121. The pixels 11, 13 are arranged in rows and columns in a matrix-like manner. The column driver circuit 120 outputs the data signals DATA1, DATA2 to the data lines 73, 78. The row driver circuit 121 provides the selection signals SEL1, SEL2 to the selection lines 74, 75. The display device 10 comprises n m pixels 11, 13. In this example, each pixel comprises exactly one sub-pixel. Here, n is the number of columns and m is the number of rows. In a realization of the sub-pixels as shown in FIG. 3B, the display device 10 thus comprises the number n of data lines 73, 78, which may also be called column lines Column lines. Further, the display device 10 comprises the number 2·m of selection lines 74, 75, which may also be called row lines. The display device 10 comprises a control circuit 122 that is coupled to, for example, the column driver circuit 120 and/or the row driver circuit 121. The control circuit 122 outputs information to the gap driver circuit 120 and/or the row driver circuit 121 as to whether a pixel is activated via the first selection signal SELL or via the second selection signal SEL2. The control circuit 122 comprises, for example, a memory for storing this information.

In an alternative embodiment not shown, the first pixel 11 comprises not only the sub-pixel 12, but also the first further sub-pixel 110 and/or the first additional sub-pixel 111. The same applies to the further pixels.

In an alternative embodiment not shown, the display device 10 comprises pixels as shown in FIG. 3C. Here, the display device 10 comprises the number 2·n of data lines 73, 78, 82, 83 (also called column lines) and the number m of selection lines 74 (also called row lines).

The present application claims priority to German application DE 102021104246.1, the disclosure content of which is incorporated by reference.

The invention is not limited to the embodiments by the description of the invention based on the embodiments. Rather, the invention encompasses any new feature as well as any combination of features, which in particular comprises any combination of features in the claims, even if that feature or combination itself is not explicitly recited in the claims or embodiments.

### LIST OF REFERENCE SIGNS

10 display device
11 first pixel
12 first sub-pixel
13 second pixel
14 second sub-pixel
15 first light-emitting device
16 first transistor
17 first supply connection
18 second supply connection
19 control terminal
20 first capacitor
21 first driver circuit
28 second transistor
29 second driver circuit
30 control terminal
31 second capacitor
32 summation node
40 second light-emitting device
41 third transistor
42 control terminal
43 third capacitor
50 third light-emitting device
51 fourth transistor
52 fourth capacitor
55 third pixel
56 third sub-pixel
57 fifth transistor
58 fifth capacitor
60 fourth pixel
61 fourth sub-pixel
62 sixth transistor
63 sixth capacitor
71 first selection transistor
72 second selection transistor
73 first data line
74 first selection line
75 second selection line
76 third selection transistor
77 fourth selection transistor
78 second data line
79 third selection line
80 fourth selection line
82 further first data line
83 further second data line
84 further selection line
94 fourth light-emitting device
95 third driver circuit
96 additional transistor
98 additional capacitor
100 fifth light-emitting device
101 fourth driver circuit
103 other transistor
105 other capacitor
107 further transistor
109 further capacitor
110 first further sub-pixel
111 first additional sub-pixel
112 second further sub-pixel
113 second additional sub-pixel
120 column driver circuit
121 row driver circuit
122 control circuit
DATA1, DATA2 data signal
GND reference potential
IT1 to IT5 current
IL1 to IL3 operating current
SELL, SEL2 select signal
UG1 to UG3 control voltage
VDD supply voltage

1. A display device, comprising
a first pixel with a first sub-pixel and a second pixel with a second sub-pixel,
wherein the first sub-pixel comprises a first light-emitting device, a first transistor, and a first driver circuit,
wherein the first driver circuit is coupled on its output side to a control terminal of the first transistor,
wherein the first transistor is coupled to the first light-emitting device,
wherein the second sub-pixel comprises a second transistor and a second driver circuit,
wherein the second driver circuit is coupled on its output side to a control terminal of the second transistor, and
wherein the second transistor is coupled to the first light-emitting device.

2. The display device according to claim 1,
wherein the display device comprises a first and a second supply terminal, and
wherein a parallel connection of the first and the second transistors couples the first supply terminal to a summing node, and
wherein the first light-emitting device couples the summing node to the second supply terminal.

3. The display device according to claim 2,
wherein the first sub-pixel comprises a first capacitor coupling the control terminal of the first transistor to the first supply terminal, and
wherein the second sub-pixel comprises a second capacitor coupling the control terminal of the second transistor to the first supply terminal.

4. The display device according to claim 1,
wherein the first driver circuit is configured to control the first transistor in response to a first data signal supplied to the first driver circuit, and
wherein the second driver circuit is configured to control the second transistor in response to a second data signal supplied to the second driver circuit.

5. The display device according to claim 1,
wherein the first sub-pixel comprises a second light-emitting device and a third transistor,
wherein the first driver circuit is coupled on its output side to a control terminal of the third transistor,
wherein the third transistor is coupled to the second light-emitting device,
wherein the second sub-pixel comprises a third light-emitting device and a fourth transistor,
wherein the second driver circuit is coupled on its output side to a control terminal of the fourth transistor,
wherein the fourth transistor is coupled to the third light-emitting device, and
wherein the first, second and third light-emitting devices are disposed adjacent one another and are adapted to emit radiation in the same wavelength range.

6. The display device according to claim 5,
wherein the first driver circuit is configured to control the first and third transistors such that in a first mode of operation the second light-emitting device emits radiation and in a second mode of operation the first light-emitting device emits radiation,
wherein in the first mode of operation the first and the second light-emitting devices are operable, and
wherein in the second mode of operation the second light-emitting device is inoperative and the first light-emitting device is operative.

7. The display device according to claim 5,
wherein the second driver circuit is configured to control the second and fourth transistors such that in the first mode of operation the first light-emitting device emits radiation and in a third mode of operation the third light-emitting device emits radiation, and
wherein in the third mode of operation the first light-emitting device is inoperative and the third light-emitting device is operative.

8. The display device according to claim 5,
wherein the first, second and third light-emitting devices are free of coupling to further pixels or sub-pixels of the display device.

9. The display device according to claim 5,
wherein the first and the second driver circuits are configured to control the first, second, third, and fourth transistors such that in a first mode of operation the second and third light-emitting devices emit radiation and in a second mode of operation the first and the second light-emitting devices or the first and the third light-emitting devices or only the first light-emitting device emits radiation.

10. The display device according to claim 1,
wherein the display device comprises a third pixel having a third sub-pixel,
wherein the third sub-pixel comprises a fourth light-emitting device, a fifth and an additional transistor, and a third driver circuit,
wherein the third driver circuit is coupled on its output side to a control terminal of the fifth transistor and a control terminal of the additional transistor,
wherein the fifth transistor is coupled to the first light-emitting device, and the additional transistor is coupled to the fourth light-emitting device.

11. The display device according to claim 10,
wherein the third driver circuit is configured to control the fifth and additional transistors such that in the first mode of operation the fourth light-emitting device emits radiation and in a fourth mode of operation the first light-emitting device emits radiation.

12. The display device according to claim 10,
wherein the display device comprises a fourth pixel having a fourth sub-pixel,
wherein the fourth sub-pixel comprises a fifth light-emitting device, a sixth and another transistors, and a fourth driver circuit,
wherein the fourth driver circuit is coupled on its output side to a control terminal of the sixth transistor and a control terminal of the other transistor,
wherein the sixth transistor is coupled to the fifth light-emitting device, and
wherein the other transistor is coupled to the first light-emitting device.

13. A display device,
comprising a first pixel with a first sub-pixel,
wherein the first sub-pixel comprises a first and a second light-emitting device, a first and a further transistor, and a first driver circuit,
wherein the first driver circuit is coupled on its output side to a control terminal of the first transistor and to a control terminal of the further transistor,
wherein the first transistor is coupled to the first light-emitting device,
wherein the further transistor is coupled to the second light-emitting device,
wherein the first driver circuit is configured to control the first transistor and the further transistor such that, in a first mode of operation, the second light-emitting device emits radiation and, in a second mode of operation, the first light-emitting device emits radiation.

14. A method of operating a display device,
wherein the display device comprises a first and a second pixel,
wherein a first sub-pixel of the first pixel comprises a first light-emitting device, a first transistor and a first driver circuit, and
wherein a second sub-pixel of the second pixel comprises a second transistor and a second driver circuit,
the method comprising:
outputting a first control voltage to the first transistor by the first driver circuit,
setting a first current flowing through the first transistor as a function of the first control voltage,
outputting a second control voltage to the second transistor through the second driver circuit,
setting a second current flowing through the second transistor as a function of the second control voltage, and
emitting radiation by the first light-emitting device as a function of the sum of the first and second currents.

15. The display device according to claim 13,
wherein the display device comprises a second picture element comprising a second sub-picture element,
wherein the first and second sub-picture elements are realized as green sub-picture elements,
wherein the first picture element comprises a red and a blue sub-picture element, and
wherein the second picture element comprises a red and a blue sub-picture element.

16. The method according to claim 14,
wherein the first sub-pixel comprises a second light-emitting device and a third transistor,
wherein the first driver circuit is coupled on its output side to a control terminal of the third transistor,
wherein the third transistor is coupled to the second light-emitting device,
wherein the second sub-pixel comprises a third light-emitting device and a fourth transistor,
wherein the second driver circuit is coupled on its output side to a control terminal of the fourth transistor,
wherein the fourth transistor is coupled to the third light-emitting device,
wherein the first, second and third light-emitting devices are disposed adjacent one another and are adapted to emit radiation in the same wavelength range, and
wherein the method comprises:
outputting a third control voltage to the third transistor by the first drive circuit, and
setting a third current flowing through the third transistor,
wherein an operating current flowing through the second light emitting device has at least the value of the third current.

17. The method according to claim 16,
wherein the display device comprises a third pixel having a third sub-pixel,
wherein the third sub-pixel comprises a fourth light-emitting device, a fifth and an additional transistor, and a third driver circuit,
wherein the third driver circuit is coupled on its output side to a control terminal of the fifth transistor and a control terminal of the additional transistor,
wherein the fifth transistor is coupled to the first light-emitting device, and
wherein the additional transistor is coupled to the fourth light-emitting device.
